(19) United States
(12) Patent Application Publication
(10) Pub. No.: US 2026/0279062 A1
(43) Pub. Date: Sep. 17, 2026

(54) DETERMINATION APPARATUS

(71) Applicant: ISUZU MOTORS LIMITED, Yokohama-shi (JP)

(72) Inventor: Tomoaki SHIMOZAWA, Fujisawa-shi (JP)

(21) Appl. No.: 19/464,737

(22) Filed: Jan. 30, 2026

(30) Foreign Application Priority Data
Mar. 12, 2025 (JP) 2025-039176

(51) Int. Cl. G06V 20/52; G06F 40/289; G06V 10/40; G06V 10/75; G06V 10/82; G06V 10/86; G06V 40/10

(52) U.S. Cl. CPC G06V 20/52; G06F 40/289; G06V 10/40; G06V 10/75; G06V 10/82; G06V 10/86; G06V 40/10

(57) ABSTRACT

A determination apparatus includes: a first acquisition unit that acquires a first caption corresponding to each of a plurality of first images obtained by capturing a monitoring area in a normal state in which no abnormality has occurred; a second acquisition unit that acquires a second caption corresponding to a second image obtained by capturing the monitoring area after the plurality of first images have been captured; a calculation unit that calculates degrees of matching between each of the plurality of first captions and the second caption by inputting the plurality of acquired first captions and the acquired second caption into a model that calculates a degree of matching between captions; and a determination unit that determines that an abnormality has occurred in the monitoring area when all of the plurality of calculated degrees of matching are less than a threshold value.

### CROSS-REFERENCE TO RELATED APPLICATIONS

The present application claims priority to Japanese Patent Applications No. 2025-39176, filed on Mar. 12, 2025, contents of which are incorporated herein by reference in their entirety.

### BACKGROUND OF THE INVENTION

The present disclosure relates to a determination apparatus that determines whether an abnormality has occurred in a monitoring area. A technique is known in which whether or not an abnormality is present is determined on the basis of an image obtained by capturing a monitoring area. Japanese Unexamined Patent Application Publication No. 2019-096179 discloses a technique in which feature quantities are extracted from an image obtained by capturing a person in a monitoring area, words constituting an image description generated in accordance with the extracted feature quantities are compared with words indicating abnormal behavior, and abnormal behavior of the person is determined based on the comparison.

However, since the manner in which light is incident on a person, the clothing of the person, the physique of the person, and the like vary, feature quantities extracted from images vary from image to image. Therefore, in order to appropriately learn feature quantities corresponding to abnormal behavior, it has been necessary to prepare a large number of images of abnormal states that are obtained by changing the manner in which light is incident on a person, changing the clothing of the person, or capturing images of persons having different physiques.

### BRIEF SUMMARY OF THE INVENTION

The present disclosure has been made in view of these points, and its object is to perform abnormality determination on a monitoring area without preparing a large number of images for learning.

A first aspect of the present disclosure provides a determination apparatus including: a first acquisition unit that acquires a first caption corresponding to each of a plurality of first images obtained by capturing a monitoring area in a normal state in which no abnormality has occurred; a second acquisition unit that acquires a second caption corresponding to a second image obtained by capturing the monitoring area after the plurality of first images have been captured; a calculation unit that calculates degrees of matching between each of the plurality of first captions and the second caption by inputting the plurality of acquired first captions and the acquired second caption into a model that calculates a degree of matching between captions; and a determination unit that determines that an abnormality has occurred in the monitoring area when all of the plurality of calculated degrees of matching are less than a threshold value.

### BRIEF DESCRIPTION OF THE DRAWINGS

FIG. 1 is a diagram for explaining a configuration of a determination apparatus.

FIG. 2 is a schematic diagram illustrating an example of a first image.

FIG. 3 is a diagram illustrating a caption generation model.

FIG. 4 is a schematic diagram illustrating an example of a second image.

FIG. 5 is a diagram for explaining a second caption corresponding to the second image.

FIG. 6 is a diagram for explaining a degree-of-matching calculation model.

FIG. 7 is a table showing a specific example of a degree of matching between captions.

FIG. 8 is a diagram for explaining an integrated model.

FIG. 9 is a flowchart showing an example of a process of determining whether an abnormality has occurred in a monitoring area.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of a determination apparatus 200

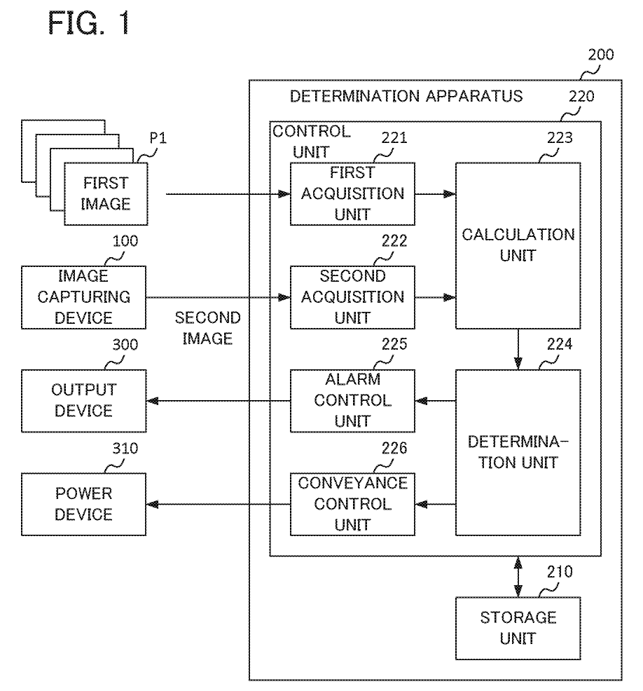

FIG. 1 is a diagram illustrating a configuration of a determination apparatus 200. The determination apparatus 200 is an apparatus that determines whether an abnormality involving a person entering a monitoring area in which entry by persons is prohibited has occurred. The monitoring area is, for example, within a predetermined range including a conveyance path along which automobile parts are conveyed in an automobile assembly plant, but is not limited thereto. The determination apparatus 200 has a function of stopping conveyance of the automobile parts on the basis of a determination result as to whether or not an abnormality has occurred. The determination apparatus 200 includes a storage unit 210 and a control unit 220.

The storage unit 210 is a storage medium including a read only memory (ROM), a random access memory (RAM), a hard disk, and the like. The storage unit 210 stores a program executed by the control unit 220.

The control unit 220 is a calculation resource including a processor such as a central processing unit (CPU). The control unit 220 implements functions of a first acquisition unit 221, a second acquisition unit 222, a calculation unit 223, a determination unit 224, an alarm control unit 225, and a conveyance control unit 226 by executing the program stored in the storage unit 210.

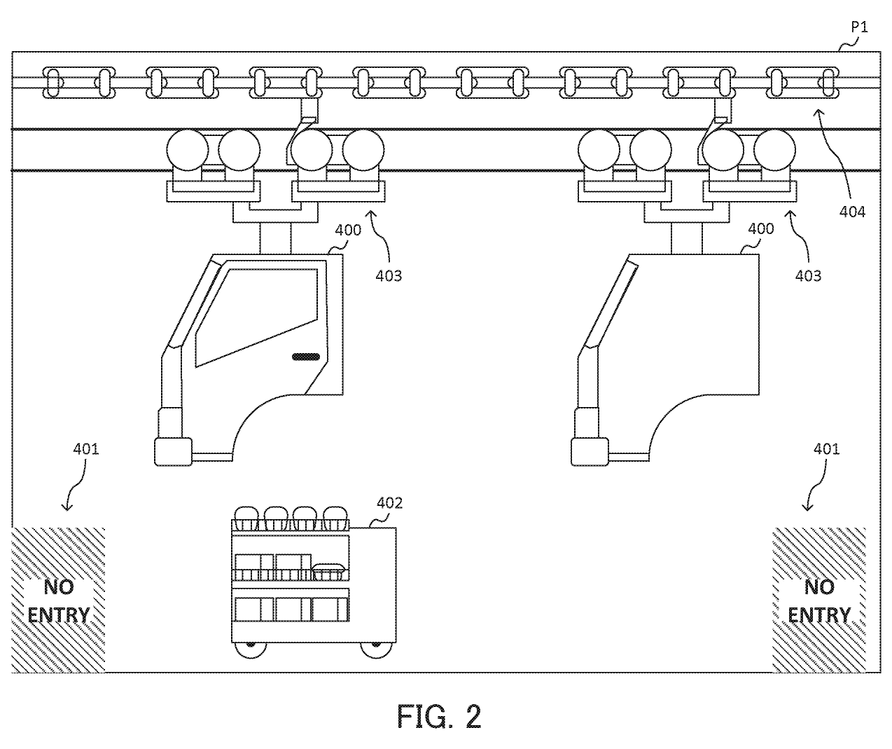

The first acquisition unit 221 acquires a first image P1 obtained by capturing an image of the monitoring area into which entry by persons is prohibited. FIG. 2 is a schematic diagram illustrating an example of the first image P1. The first image P1 in FIG. 2 shows a state in which automobile parts 400 are conveyed, an entry-prohibited sign 401 is provided, and a conveyance robot 402 conveys the parts. In addition, in the first image P1, a fleet trolley 403 that conveys the parts 400 and a drive chain 404 that moves the fleet trolley 403 are shown. The drive chain 404 is moved by a power device 310. In other words, the power device 310 moves the fleet trolley 403 by moving the drive chain 404, and conveys the parts 400. The power device 310 is, for example, a motor or an engine. The first image P1 is an image obtained by capturing the monitoring area in a normal state. The normal state is a state in which no abnormality involving a person entering the monitoring area has occurred. The first image P1 is an image captured by an image capturing device 100.

The image capturing device 100 is, for example, a camera installed in the automobile assembly plant. The image capturing device 100 captures an image of the monitoring area in which entry by persons is prohibited in the assembly plant. A user of the determination apparatus 200 inputs, to the determination apparatus 200, a plurality of first images P1 obtained by capturing the monitoring area in the normal state, among a plurality of images obtained by capturing the monitoring area with the image capturing device 100. The plurality of first images P1 are different from each other and, for example, differ with regard to an image capturing date and time, weather at the time of image capturing, and settings at the time of image capturing. In other words, the plurality of first images P1 differ from each other in the manner in which light is incident on the monitoring area, settings, and the like. The first acquisition unit 221 acquires the plurality of first images P1 input to the determination apparatus 200 by the user. In other words, the first acquisition unit 221 acquires the plurality of first images P1 that are captured by having the user operate the image capturing device 100.

The first acquisition unit 221 acquires a first caption corresponding to each of the plurality of first images P1. The first caption is a description corresponding to the first image P1. Specifically, the first caption is a sentence indicating an event that has occurred in the monitoring area, an object in the monitoring area, and a state of the object, and is a sentence indicating the monitoring area in the normal state. The first acquisition unit 221 acquires the first caption of each of the plurality of first images P1 by inputting the plurality of first images P1 into a caption generation model. The caption generation model is a trained large-scale language model that, when an image is input, generates a caption corresponding to the image.

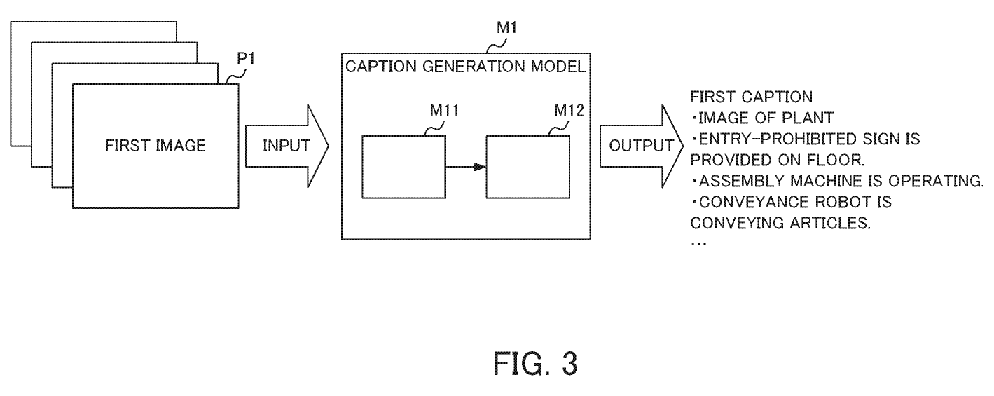

FIG. 3 is a diagram for explaining a caption generation model M1. The caption generation model M1 includes, for example, an image feature extraction unit (encoder) M11 and a sentence generation unit (decoder) M12. The image feature extraction unit M11 extracts feature quantities of the input image using a technique such as a convolutional neural network. The sentence generation unit M12 generates a caption of an image using, for example, a recursive neural network on the basis of the extracted feature quantities of the image. A specific example of the caption generation model M1 is a CLIP (Contrastive Language-Image Pre-training) model trained on a large number of pairs of images and captions, but is not limited thereto.

By inputting one image to the caption generation model M1, the first acquisition unit 221 acquires one first caption corresponding to the one image. By inputting each of the plurality of first images P1 to the caption generation model M1, the first acquisition unit 221 acquires a first caption corresponding to each first image P1. Specific examples of the first caption include, “an image of a plant”, “an entry-prohibited sign is provided on a floor”, “an assembly machine is operating”, and “a conveyance robot is conveying articles”, but are not limited thereto.

The first acquisition unit 221 stores the plurality of acquired first captions in the storage unit 210. The storage unit 210 stores the plurality of first captions acquired by the first acquisition unit 221. The first acquisition unit 221 acquires the plurality of first captions stored in the storage unit 210 at an arbitrary timing.

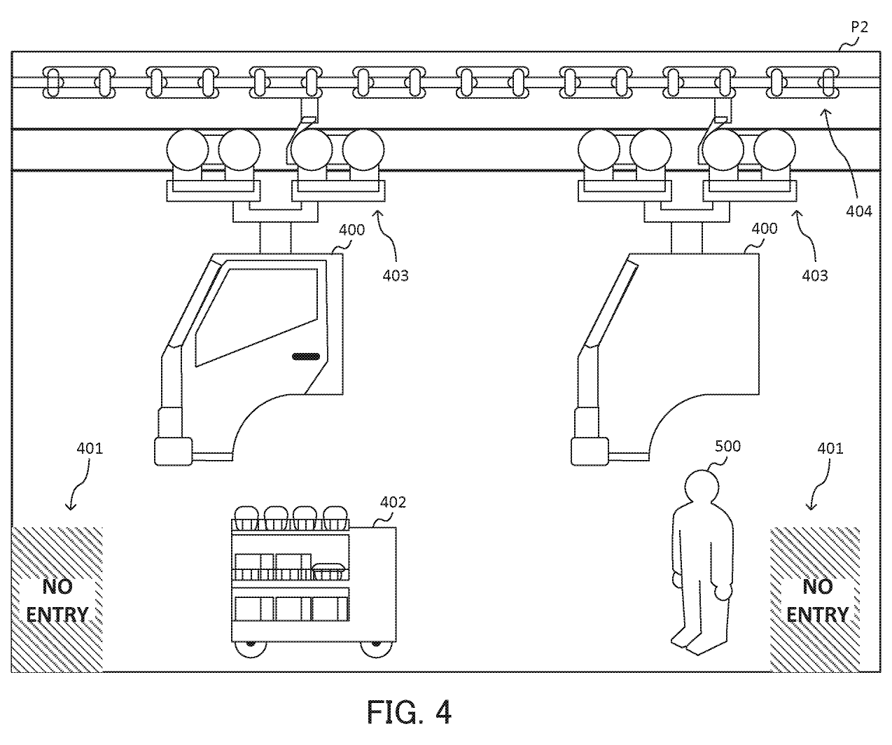

The second acquisition unit 222 acquires a second image from the image capturing device 100. FIG. 4 is a schematic diagram illustrating an example of a second image P2. The second image P2 is an image obtained by capturing the monitoring area with the image capturing device 100 after the first caption of each of the plurality of first images P1 is stored in the storage unit 210. In the second image P2 illustrated in FIG. 4, in addition to the parts 400, the sign 401, and the conveyance robot 402 shown in the first image P1, a person 500 is shown. In addition, in the second image P2, the fleet trolley 403 that conveys the parts 400 and the drive chain 404 that moves the fleet trolley 403 are shown.

The image capturing device 100 generates the second image P2 by capturing the monitoring area at predetermined intervals. The predetermined interval is, for example, one second, but is not limited thereto. By inputting the acquired second image P2 to the caption generation model M1, the second acquisition unit 222 acquires a second caption corresponding to the second image P2. The second caption is a description corresponding to the second image P2. The second caption is a sentence indicating an event that occurred in the monitoring area, an object in the monitoring area, and a state of the object. The second acquisition unit 222 may acquire the second caption corresponding to the second image P2 by inputting the second image P2 to a trained large-scale language model different from the caption generation model M1.

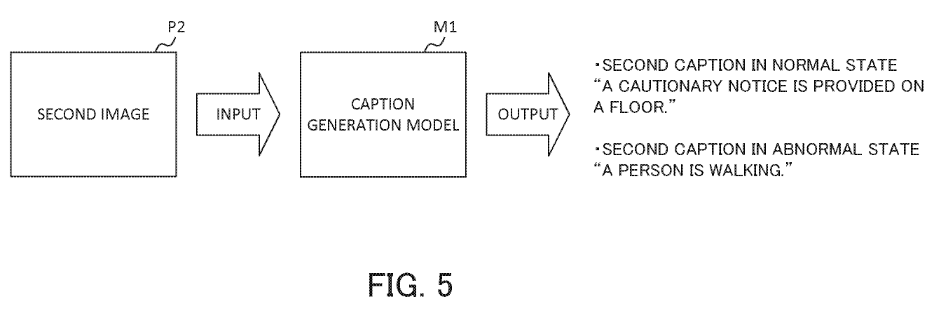

FIG. 5 is a diagram for explaining the second caption corresponding to the second image P2. The second caption corresponding to the second image P2 changes depending on the second image P2 input to the caption generation model M1. The second caption, in the case where the monitoring area shown in the second image P2 is in the normal state, is similar to the first caption. The second caption in the case where the monitoring area of the second image P2 is in the normal state is, for example, “a cautionary notice is provided on a floor”. The second caption, in the case where the monitoring area of the second image P2 is in an abnormal state, differs from the first caption. The abnormal state is a state in which an abnormality involving a person entering the monitoring area has occurred. The second caption in the case where the monitoring area of the second image P2 is in the abnormal state is, for example, “a person is walking”. As described above, the second caption corresponding to the second image P2 changes depending on whether or not the abnormality has occurred in the monitoring area.

The calculation unit 223 calculates degrees of matching between each of the plurality of first captions and the second caption. The degree of matching is a degree indicating how much each first caption corresponds to the second caption, or a degree of relevance therebetween. A high degree of matching between the first caption and the second caption indicates that the first caption and the second caption are descriptions having the same meaning. The calculation unit 223 calculates the degrees of matching between each of the plurality of first captions and the second caption by inputting the plurality of first captions and the second caption into a degree-of-matching calculation model that calculates a degree of matching between the captions. Specifically, the calculation unit 223 calculates the degrees of matching between each of the plurality of first captions and the second caption by inputting the plurality of first captions stored in the storage unit 210 acquired by the first acquisition unit 221 and the second caption acquired by the second acquisition unit 222 into the degree-of-matching calculation model.

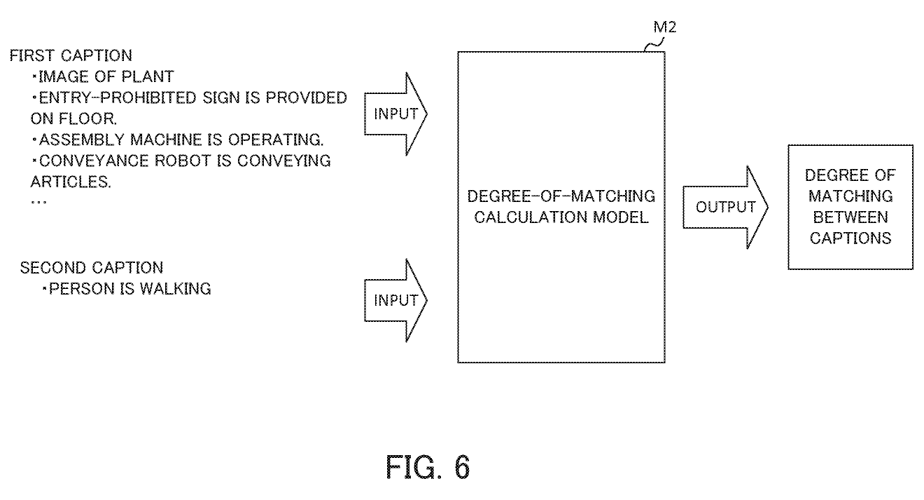

FIG. 6 is a diagram for explaining a degree-of-matching calculation model M2. The degree-of-matching calculation model M2 is a trained model that calculates, when two captions are input, a degree of matching between the two captions. The degree-of-matching calculation model M2 converts the input caption into a numerical vector. As a method of converting a caption into a numerical vector, for example, a method based on word occurrence frequency (such as Bag-of-Words or TF-IDF), and a method that considers semantic relationships between words (such as Word2Vec, GloVe, or BERT) can be used, and other known techniques can also be used.

The degree-of-matching calculation model M2 calculates similarity between vectors of two captions converted into numerical vectors. Methods for calculating similarity include cosine similarity, Euclidean distance, and the Jaccard coefficient, but the methods are not limited thereto, and known techniques may be used. The degree-of-matching calculation model M2 calculates, as the degree of matching between two captions, a degree of matching that is not less than 0 and not more than 1.

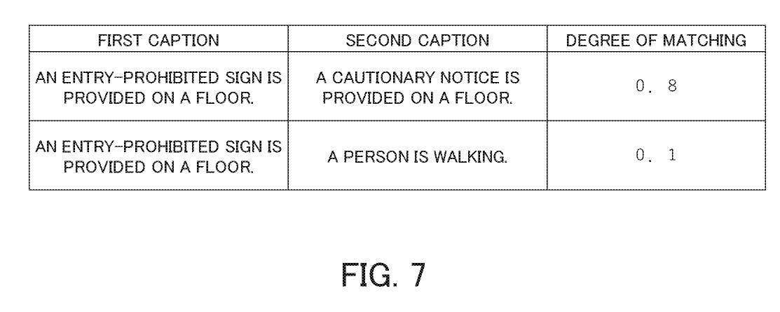

Specific examples of the degree of matching between captions will be described. FIG. 7 is a table showing specific examples of the degree of matching between captions. For example, the degree of matching when the first caption is “an entry-prohibited sign is provided on a floor” and the second caption is “a cautionary notice is provided on a floor” is 0.8. The degree of matching when the first caption is “an entry-prohibited sign is provided on a floor” and the second caption is “a person is walking” is 0.1.

Since the plurality of first captions indicate the monitoring area in the normal state, when the degree of matching between any of the plurality of first captions and the second caption is high, it can be said that the monitoring area indicated by the second image P2 corresponding to the second caption is in the normal state in which no abnormality has occurred. Therefore, the determination unit 224 determines whether or not the abnormality has occurred in the monitoring area on the basis of the degree of matching. When at least one of a plurality of degrees of matching is equal to or greater than a threshold value, the determination unit 224 determines that the monitoring area is in the normal state in which no abnormality has occurred. The threshold value may be appropriately determined by experiment or the like, and a specific value is, for example, 0.5.

When all degrees of matching between each of the plurality of first captions and the second caption are below the threshold value, it can be said that the monitoring area shown in the second image P2 corresponding to the second caption is not in the normal state and the abnormality has occurred. When all of the plurality of degrees of matching are less than the threshold value, the determination unit 224 determines that the abnormality has occurred in the monitoring area. Specifically, when all of the plurality of degrees of matching are less than the threshold value, the determination unit 224 determines that the abnormality involving a person entering the monitoring area has occurred.

In this way, the determination unit 224 does not determine whether the abnormality has occurred by using the image itself obtained by capturing the monitoring area, but determines the presence or absence of the abnormality by comparing the degree of matching between (i) the caption of the first image P1 obtained by capturing the monitoring area in the normal state and (ii) the second caption of the second image P2 captured after the capturing of the first image P1. When a caption is generated from an image, information such as the manner in which light is incident and camera settings is excluded, and only sentences representing events occurring in the monitoring area and objects in the monitoring area and states of the objects are extracted. That is, by determining the presence or absence of the abnormality on the basis of the degree of matching between captions, the determination unit 224 can determine whether the abnormality has occurred in the monitoring area while reducing the influence of the manner in which light is incident on the monitoring area, camera settings, and the like. As a result, the determination unit 224 can appropriately determine whether the abnormality has occurred in the monitoring area while reducing the influence of the manner in which light is incident, camera settings, and the like, without preparing a large number of images for learning in which the manner in which light is incident on an object in the monitoring area, camera settings, and the like are changed.

The alarm control unit 225 issues an alarm when it is determined that the abnormality has occurred in the monitoring area. Specifically, when it is determined that the abnormality has occurred in the monitoring area, the alarm control unit 225 causes the output device 300 that outputs the alarm to issue an alarm. The output device 300 includes a buzzer or speaker. The alarm control unit 225 causes the output device 300 to issue an audio alarm, “a person has intruded into a no-entry area”, indicating that the abnormality involving a person entering the monitoring area has occurred.

The conveyance control unit 226 stops the conveyance of the automobile parts 400 on the basis of the determination result of the determination unit 224. When it is determined that the abnormality has occurred in the monitoring area, the conveyance control unit 226 stops conveyance of the automobile parts 400. When there is an abnormality in the monitoring area, the conveyance control unit 226 stops conveyance of the automobile parts 400 by stopping the operation of the power device 310 that moves the drive chain 404. The power device 310 is, for example, a motor or an engine. As described above, in a case where the abnormality involving a person entering the monitoring area has occurred, by stopping conveyance of the parts 400, the conveyance control unit 226 can suppress contact between the parts 400 and the person, and thus can improve safety in the monitoring area.

### Modification 1

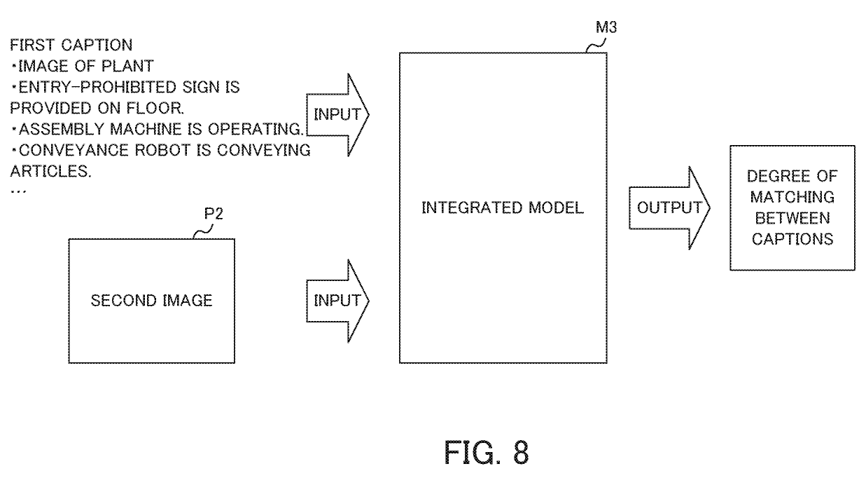

In the above-described embodiment, the second acquisition unit 222 acquires the second caption, and the calculation unit 223 calculates the degrees of matching by inputting the plurality of first captions and the second caption into the degree-of-matching calculation model M2. Alternatively, the determination apparatus 200 may use an integrated model in which a model for generating a caption when an image is input and a model for calculating a degree of matching between captions are integrated. FIG. 8 is a diagram for explaining an integrated model M3.

The integrated model M3 is a model for calculating degrees of matching between a second caption of the second image P2 and each of a plurality of first captions by inputting each of the plurality of first captions and the second image P2. The integrated model M3 is, for example, a model obtained by combining the caption generation model M1 and the degree-of-matching calculation model M2. Specifically, when the plurality of first captions and the second image P2 are input, the integrated model M3 generates a second caption corresponding to the second image P2, and calculates degrees of matching between the generated second caption and each of the plurality of first captions. In this manner, the determination apparatus 200 calculates, using the integrated model M3, the degrees of matching between the second caption of the second image P2 and the plurality of first captions, and can determine whether the abnormality has occurred in the monitoring area.

### Modification 2

The monitoring area of the above embodiment is the area in which entry by persons is prohibited. However, the monitoring area is not limited thereto, and any area may be set as the monitoring area. For example, the monitoring area may be an area in which entry by persons into a part of the area is prohibited, or an area in which entry by persons into the entire area is permitted. In addition, the monitoring area of the above-described embodiment is an automobile assembly plant, but the monitoring area is not limited thereto. The monitoring area may be, for example, an office, an urban area, a station, or a commercial facility.

### Modification 3

The second acquisition unit 222 of the above embodiment acquires one second caption from the second image P2. The second acquisition unit 222 of Modification 3 acquires a plurality of second captions from the second image P2. The second acquisition unit 222 acquires, as the second captions, “a cautionary notice is provided on a floor” and “a person is walking” from the second image P2 illustrated in FIG. 3, for example.

The calculation unit 223 calculates degrees of matching between each of the plurality of second captions and each first caption. As a specific example, the calculation unit 223 calculates the degrees of matching between the second caption “a cautionary notice is provided on a floor" and each of the first captions “an image of a plant”, “an entry-prohibited sign is provided on a floor”, “an assembly machine is operating”, and “a conveyance robot is conveying articles”. The calculation unit 223 calculates the degree of matching between “a cautionary notice is provided on a floor” and “an entry-prohibited sign is provided on a floor” as 0.8, and calculates the degrees of matching between “a cautionary notice is provided on a floor” and the first captions other than the caption “an entry-prohibited sign is provided on a floor” as 0.1. The calculation unit 223 sets the highest degree of matching [0.8] among the plurality of degrees of matching corresponding to the caption “a cautionary notice is provided on a floor” as the degree of matching of “a cautionary notice is provided on a floor”.

Similarly, the calculation unit 223 calculates the degrees of matching between the second caption “a person is walking” and each of the first captions “an image of a plant”, “an entry-prohibited sign is provided on a floor”, “an assembly machine is operating”, and “a conveyance robot is conveying articles”. The calculation unit 223 calculates the degree of matching between “a person is walking” and each first caption as 0.1. The calculation unit 223 sets the highest degree of matching [0.1] among the plurality of degrees of matching corresponding to the caption “a person is walking” as the degree of matching of “a person is walking”.

The determination unit 224 determines whether the monitoring area is in the abnormal state on the basis of whether all of the degrees of matching between each of the plurality of second captions and each first caption are equal to or greater than the threshold value. When all of the plurality of degrees of matching are equal to or greater than the threshold value, the determination unit 224 determines that the monitoring area is in the normal state. The determination unit 224 determines that the monitoring area is in the abnormal state when any of the plurality of degrees of matching is less than the threshold value. As a specific example, the determination unit 224 determines that the monitoring area is in the abnormal state when the degree of matching [0.1] corresponding to the caption “a person is walking” is less than the threshold value [0.5]. As described above, the determination unit 224 determines that the monitoring area is in the abnormal state when the degree of matching between any of the plurality of second captions of the second image P2 and each first caption is less than the threshold value. In this way, even if an abnormal state that cannot be predicted in advance occurs, the determination unit 224 can determine that the monitoring area is in an abnormal state.

### Process of determining whether an abnormality has occurred

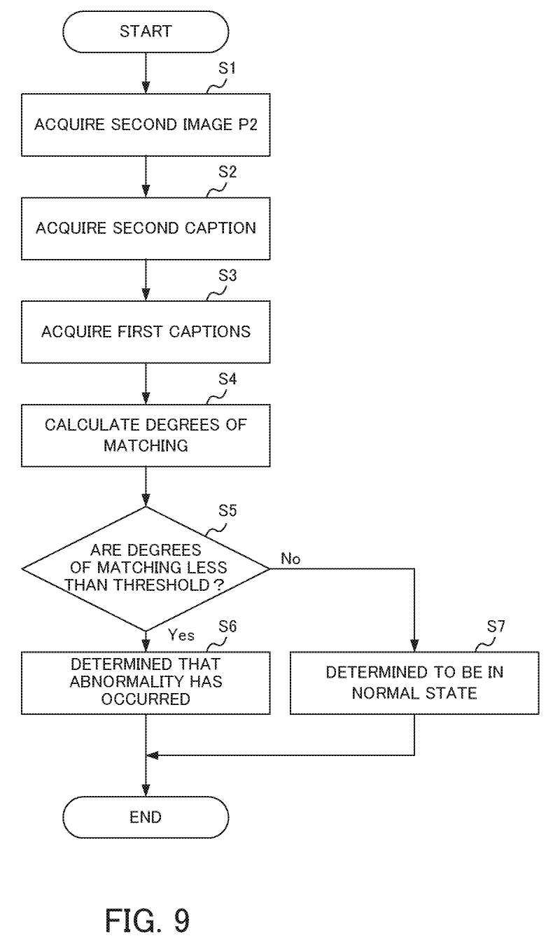

FIG. 9 is a flowchart illustrating an example of a process of determining whether an abnormality has occurred in the monitoring area. It is assumed that first captions of a plurality of first images P1 obtained by capturing the monitoring area in a normal state in which no abnormality has occurred are stored in the storage unit 210.

The second acquisition unit 222 acquires a second image P2 captured by the image capturing device 100 in the monitoring area (step S1). The second acquisition unit 222 acquires a second caption corresponding to the second image P2 (step S2). The second acquisition unit 222 acquires the second caption corresponding to the second image P2 by inputting the second image P2 into the caption generation model M1 that, when an image is input, generates a caption corresponding to the image.

The first acquisition unit 221 acquires a plurality of first captions (step S3). The first acquisition unit 221 acquires the plurality of first captions stored in the storage unit 210 upon the second acquisition unit 222 acquiring the second image P2.

The calculation unit 223 calculates degrees of matching between each of the plurality of first captions and the second caption (step S4). The calculation unit 223 calculates the degrees of matching by inputting each of the plurality of first captions and the second caption into the degree-of-matching calculation model M2 that calculates a degree of matching between captions.

The determination unit 224 determines whether the degree of matching is less than a threshold (step S5). The determination unit 224 determines whether all of the plurality of degrees of matching are less than the threshold value. If all of the plurality of degrees of matching are less than the threshold value (Yes in step S5), the determination unit 224 determines that an abnormality involving a person entering the monitoring area has occurred (step S6). If at least one of the plurality of degrees of matching is equal to or greater than the threshold value (No in step S5), the determination unit 224 determines that the monitoring area is in the normal state in which no abnormality involving a person entering the monitoring area has occurred (step S7).

### Effects of the determination apparatus 200

As described above, the determination apparatus 200 acquires the first caption corresponding to each of the plurality of first images P1 obtained by capturing the monitoring area in a normal state in which no abnormality has occurred, and the second caption corresponding to the second image P2 obtained by capturing the monitoring area after the plurality of first images P1 have been captured. Next, the determination apparatus 200 calculates the degrees of matching between each of the plurality of first captions and the second caption by inputting the plurality of acquired first captions and the acquired second caption into the degree-of-matching calculation model M2 that calculates a degree of matching between captions. Then, when all of the calculated plurality of degrees of matching are less than the threshold value, the determination apparatus 200 determines that the abnormality has occurred in the monitoring area.

As described above, the determination apparatus 200 does not determine whether an abnormality has occurred by using the image itself obtained by capturing the monitoring area, but compares the degree of matching between the caption of the first image P1 obtained by capturing the monitoring area in the normal state and the caption of the second image P2 captured after the capturing of the first image P1. When a caption is generated from an image, information such as the manner in which light is incident and camera settings is excluded, and only sentences representing events occurring in the monitoring area and objects in the monitoring area and state of the objects are extracted. In other words, by performing determination on the basis of the degree of matching between captions, the determination apparatus 200 can determine whether the abnormality has occurred in the monitoring area while reducing the influence of the manner in which light is incident on an object in the monitoring area, camera settings, and the like. As a result, the determination apparatus 200 can appropriately determine whether the abnormality has occurred in the monitoring area while reducing the influence of the manner in which light is incident, camera settings, and the like, without preparing a large number of images for learning in which the manner in which light is incident on an object in the monitoring area, camera settings, and the like are changed.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. A determination apparatus comprising:
a first acquisition unit that acquires a first caption corresponding to each of a plurality of first images obtained by capturing a monitoring area in a normal state in which no abnormality has occurred;
a second acquisition unit that acquires a second caption corresponding to a second image obtained by capturing the monitoring area after the plurality of first images have been captured;
a calculation unit that calculates degrees of matching between each of the plurality of first captions and the second caption by inputting the plurality of acquired first captions and the acquired second caption into a model that calculates a degree of matching between captions; and
a determination unit that determines that an abnormality has occurred in the monitoring area when all of the plurality of calculated degrees of matching are less than a threshold value.

2. The determination apparatus according to claim 1, wherein the determination unit determines that the monitoring area is in the normal state in which no abnormality has occurred, when at least one of the plurality of degrees of matching is equal to or greater than the threshold value.

3. The determination apparatus according to claim 1, wherein the first acquisition unit acquires the first caption of each of the plurality of first images by inputting the plurality of first images obtained by capturing the monitoring area in different normal states into a model that, when an image is input, generates a caption corresponding to the image.

4. The determination apparatus according to claim 1, wherein the second acquisition unit acquires the second caption corresponding to the second image by inputting the second image into a model that, when an image is input, generates a caption corresponding to the image.

5. The determination apparatus according to claim 4, further comprising:
a storage unit that stores the plurality of first captions, wherein the second acquisition unit acquires the second caption corresponding to the second image by inputting the second image acquired from an image capturing device that captures the monitoring area into the model, and
the first acquisition unit acquires the plurality of first captions from the storage unit when the second caption is acquired.

6. The determination apparatus according to claim 1, wherein the first acquisition unit acquires the first caption corresponding to each of the plurality of first images obtained by capturing the monitoring area in the normal state in which no abnormality involving a person entering the monitoring area in which entry by persons is prohibited has occurred, and
the determination unit determines that an abnormality involving a person entering the monitoring area has occurred, when all of the plurality of calculated degrees of matching are less than the threshold value.

7. The determination apparatus according to claim 1, further comprising:
an alarm control unit that issues an alarm when it is determined that an abnormality has occurred in the monitoring area.

8. The determination apparatus according to claim 7, wherein the alarm control unit notifies that an abnormality has occurred in the monitoring area by causing an output device configured to output the alarm to output the alarm.

9. The determination apparatus according to claim 1, wherein the second acquisition unit acquires a plurality of the second captions corresponding to the second image,
the calculation unit calculates the degrees of matching between each of the plurality of second captions and each first caption, and
the determination unit determines that the monitoring area is in the normal state when all of the plurality of degrees of matching are equal to or greater than the threshold value, and determines that an abnormality has occurred in the monitoring area when any of the plurality of degrees of matching is less than the threshold value.

10. The determination apparatus according to claim 1, further comprising:
a processor that implements functions of the first acquisition unit, the second acquisition unit, the calculation unit, and the determination unit by executing a program stored in a storage medium.

11. The determination apparatus according to claim 1, further comprising:
a conveyance control unit that stops conveyance of articles by stopping an operation of a conveyance device configured to convey the articles in the monitoring area, when the abnormality has occurred in the monitoring area.
